(19) United States
(12) Patent Application Publication
(10) Pub. No.: US 2014/0304230 A1
(43) Pub. Date: Oct. 9, 2014

(54) System and Method for Selective Replication of Electronic Data

(71) Applicant: APRIMA MEDICAL SOFTWARE, INC., Carrollton, TX (US)

(72) Inventors: Neil Simon, Carrollton, TX (US); Lonny Cordell, Carrollton, TX (US); Daniel Popp, Carrollton, TX (US)

(73) Assignee: Aprima Medical Software, Inc., Carrollton, TX (US)

(21) Appl. No.: 13/859,026

(22) Filed: Apr. 9, 2013

(51) Int. Cl. G06F 17/30

(52) U.S. Cl. CPC G06F 17/30575
USPC 707/634

(57) ABSTRACT

The improved system provides for selective replication of a subset of a larger central database. A replication structuring utility uses a first textual file to analyze the central database table schema to construct a second textual file representing an ordered list of table and record data element relationships. A client device utilizes this second textual file to determine the subset of the data that should be replicated on a client database. Root objects are defined to inform the second textual file creation and to assist in determining the optimum path through the relational table data. The client device may connect either wired or wirelessly to the central database server.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to database management utilities and, more specifically, to a system architecture that provides selective replication of a subset of a central database to a client database.

2. Description of Related Art including information disclosed under 37 CFR 1.97 and 1.98

The need for access to digital data in essentially every business activity these days has increased exponentially over a few short years and is poised to grow further still. Take, for example, the medical industry with its relatively recent push to make all patient files electronic. Massive amounts of electronic medical data now exist for pretty much everyone. Combine the personal medical data with the attendant health insurance data and the amount of information that must be retained and accessed—per patient—can be staggering. Further, all of this electronic information must typically reside in a master database that is accessible by numerous offices and individuals. For example, a physician practice group may maintain a single central database at a primary facility to allow access by a multitude of personnel and doctors. If the primary facility is a hospital, the physician practice group likely has multiple satellite offices and other facilities that, likewise, need access to the master database information.

Fortunately, to facilitate the transfer of electronic data between locations, the Internet and access to the Internet via wired and wireless devices is becoming relatively commonplace. However, although access to broadband Internet is improving, there are still many areas of the country where the network access is unreliable, poorly performing, or is simply not yet available. Thus, in these underserved areas when it is necessary to access large amounts of electronic data as typically stored in a central database, it becomes a requirement that this data be stored locally (in the underserved area) while somehow maintaining coherency with the master database so that changes to data made in one location are updated in all locations.

Maintaining database coherency with multiple databases can be commonly achieved through database replication. However, this usually entails full replication of the master database at the remote location, which can take hours—if not days—to accomplish over a limited bandwidth Internet network connection. Compounding this problem is when a wireless Internet connection must be used in some remote locations not having landline copper or optical fiber. Dropped network connections (which occur regularly with wireless networks) often result in incomplete replication or even data corruption.

Another issue arises when the database must be accessed in a mobile fashion. For example, doctors often see patients in locations away from their main offices, or even while making rounds in a hospital. It is vital for these doctors to have constant access to the necessary patient data in these remote spots, almost always accessed over a wireless network connection (Wi-Fi, cellular, etc.). To replicate the entire master database on the mobile device would be unrealistic. Thus, it becomes necessary to provide only the portion of patient information from the master database that the doctor needs, all the while maintaining coherency of that data with the master database. By replicating only a subset of the data on the mobile device, the amount of required storage and network bandwidth may be reasonably supported by an underserved network.

Numerous publicly available routines and algorithms can replicate an entire database, a subset of tables, or even a subset of rows in a table. However, each of these solutions fails when a subset of data must be replicated from a set of tables that have complex relationships and constraints among them. Database developers try to store their data in a set of normalized tables. Normalized refers to data that is stored in one location only, and relationships are used to reference this data. Thus, most real-world relational databases have a complex schema involving one to one, one to many and many to many relationships among multitudes of tables.

For example you might have a table that contains demographic data for a Patient and then another set of tables that contains information about the different insurance plans that a patient has. This is a one-to-many relationship. If a database had 100,000 patients in it and each patient has two insurances, then there would exist some 200,000 patient insurance records. However, a particular physician might be actively treating only a few hundred patients over the course of a month, so instead of replicating all 300,000 records to their mobile device it would be preferable to replicate only 200 patients and 400 patient insurance records. This would be a considerable savings on the amount of data that must be transmitted, stored, and maintained coherent. The present invention satisfies this shortcoming by providing a novel method and system for replicating only a subset of data existing in a complex schema.

### BRIEF SUMMARY OF THE INVENTION

The invention described herein includes a system for selectively replicating electronic data in a database, the system comprising: at least one central database device adapted to store a multitude of electronic data organized in a normalized table schema; and a replication structuring device adapted to utilize a first textual file, the first textual file comprising a list of root objects of interest, the replication structuring device generating a second textual file comprising an ordered listing of the central database tables based upon the first textual file input.

Other embodiments include: at least one client computing device including at least one client database device, the client computing device adapted to utilize the second generated textual file to replicate a subset of the central database within the client database; the system wherein the first textual file is an XML-based format document; the system wherein the second textual file is an XML-based format document; a replication utility adapted to generate SQL database queries based on the second textual file, wherein the SQL database queries facilitate the replication of a subset of the central database data; the system wherein the second textual file data is organized in a tree structure based upon the root objects of interest for determining the optimum order of replication of the central database tables; the system wherein the central database schema includes metadata for use by the replication structuring device to determine the order in which the central database table data must be replicated to avoid constraint violations during the subset replication; the system wherein the client computing device is in wireless communication with the central database device; an application server device in network communication with the at least one client computing device, the application server device adapted to cooperate with the at least one client computing device and the at least one central database device to assist in maintaining data coherency; and an application server device in network communication with the at least one client computing device, the application server device adapted to cooperate with the at least one client computing device and the at least one central database device to monitor the client device connection state for audit-trail purposes.

The invention described herein also includes a method for selectively replicating electronic data in a database, the method steps comprising: providing a central database including a multitude of electronic data organized in a normalized table schema; using a first textual file comprising a list of root objects of interest to generate a second textual file comprising an ordered list of table and element relationships within the central database table schema; and using the second textual file to replicate a subset of the central database within a client device database.

Other embodiments include: the method wherein the first textual file is an XML-based format document; the method wherein the second textual file is an XML-based format document; using the first textual file to determine the optimum order of replication of the central database tables; the method wherein the second textual file data is organized in a tree structure having root objects of interest for determining the optimum order of replication of the central database tables; utilizing metadata stored with the central database tables to assist in determining the order in which the central database table data must be replicated to avoid constraint violations during the subset replication;

Yet another embodiment includes the method steps further comprising: defining a plurality of root objects that are of interest within the central database records; identifying all records within the central database related to the root objects; organizing the identified records into a tree structure; and mapping the paths through the tree structure to determine the optimum paths to the root objects. Yet another embodiment includes the method steps wherein the client database is on a client computing device, the method steps further comprising: monitoring the network connection between the client computing device and the central database for audit trail purposes; and also replicating wirelessly the subset of the central database.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 depicts a block diagram of an embodiment of the system of the present invention, highlighting the network connectivity of the various system components;

FIG. 2 FIG. 2 is a flow diagram depicting certain processing steps of the cache client in maintaining data integrity and coherency with the central database;

FIG. 3 is a flow diagram depicting certain high-level processing steps taken by the embodiment in performing the overall stated functionality;

FIG. 4 is a graphical depiction of the contents of an embodiment of the first textual file including root object definitions as utilized by the present embodiment;

FIG. 5 is a flow diagram depicting certain processing steps taken by the embodiment when using the first textual file to generate a second textual file for use by the system when performing partial replication of the central database;

FIG. 6 is a graphical depiction of the contents of a portion of an embodiment of the second textual file including an ordered listing of database tables in an optimal replication order;

FIG. 7 is a flow diagram depicting certain processing steps taken by the embodiment when replicating at least a portion of the central database on a client device;

FIG. 8 is a flow diagram depicting certain processing steps taken by the embodiment when performing the initial replication process;

FIG. 9 is a flow diagram depicting certain processing steps taken by the embodiment when performing the ongoing replication process;

FIG. 10 is a flow diagram depicting certain processing steps taken by the embodiment when performing the include process; and

FIG. 11 is a flow diagram depicting certain processing steps taken by the embodiment when a row data error is encountered during replication.

The above figures are provided for the purpose of illustration and description only, and are not intended to define the limits of the disclosed invention. Use of the same reference number in multiple figures is intended to designate the same or similar parts. Furthermore, if the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

The present invention utilizes multiple networked computing devices adapted to exchange and/or access data over the network. These computing devices include any combination of well-known mainframe computers; minicomputers; database servers; workstations; personal computers; embedded computers; laptop computers; tablet computers; handheld computers; smartphones; PDAs; and any other such device capable of executing stored program instructions from a computer readable medium. These networked computing devices communicate over any wired or wireless computing network adapted to data transmission, for example: Internet; wide area network (WAN); metropolitan area network (MAN); campus area network (CAN); local area network (LAN); near area network (NAN); personal area network (PAN); near field communication (NFC); and any combination thereof. Wired network technologies include, for example: twisted pair; coaxial; home wiring; optical; and any combination thereof. Wireless network technologies include, for example: microwave; satellite; cellular/PCS; radio; infrared; Bluetooth; Zigbee; and any combination thereof. As used herein “computer readable medium” means any tangible portable or fixed RAM or ROM device, such as portable flash memory, a CDROM, a DVDROM, embedded RAM, ROM, or fixed flash memory integrated circuit devices, or the like. Reference herein to a portable client device means a computing device that is portable (for example, a desktop, laptop, tablet computer, handheld computer, PDA, smartphone, or the like), regardless of wired or wireless connectivity.

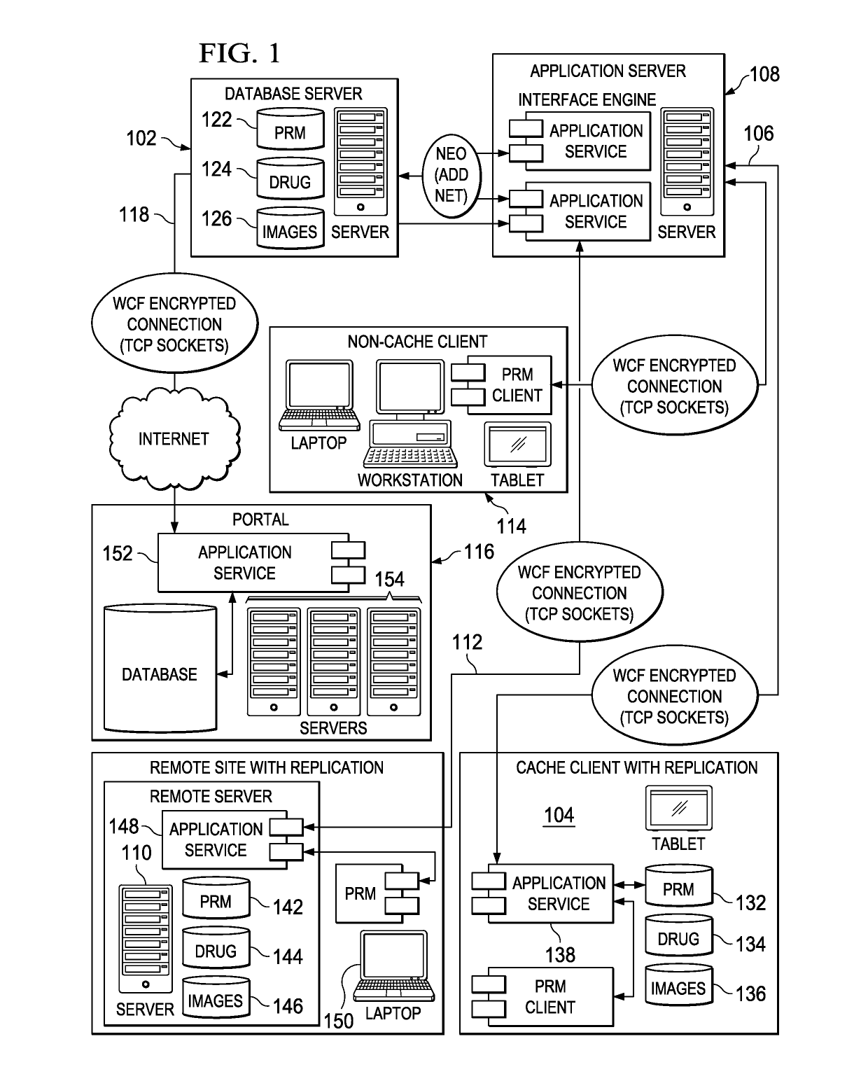

FIG. 1 depicts a block diagram of an embodiment of the system of the present invention, highlighting the network connections of the various components. The primary component includes the central database server (102) that is the source of the primary electronic data utilized by the system. The present embodiment utilizes a relational database computer server device adapted to support three different electronic database devices including patient data (122), drug data (124), and large object file data (126). This particular embodiment is configured in a tiered architecture based on a Microsoft SQL Server database using Active Directory authentication connected to application layer utilizing Microsoft's Windows Communication Framework (WCF) for secure communication. However, other embodiments may utilize similar relational database hardware and/or software adapted to achieve the novel functionality described herein.

Another embodiment may utilize a greater or lesser number of relational databases, including a single database, and may incorporate multiple types of data in a single database. The SQL server of the embodiment may be operated on a standard computing device server platform capable of supporting an SQL database. The computing power, memory, and storage capacity of this server (102) is readily determinable by the amount of data to be contained therein, the database schema, the number of expected connections, etc. One of ordinary skill in the art to which the invention pertains will understand and appreciate that sizing, configuration, operation, and maintenance of an SQL database server (software and hardware) is well understood requiring no further description herein.

The embodiment allows connections to the central database server (102) by multiple networked clients (104, 110). The clients (104, 110) do not connect directly to the database. Instead, all client connection requests are routed through an application server (108) to the central database (102). The application server (108) of the present embodiment is developed using the C# code based on Microsoft.NET, but may be written in any programming language suitable to achieve the disclosed functionality (for example, C, C++, JavaScript, or the like). The application server (108) may run as a standalone application on a dedicated computing device, or may run as a Windows Service on the database server (102). To improve system scaling, the application server (108) layer can consists of one or more application servers running on one or more separate server computing devices, or can be run on the database server (102) for smaller installations. The application server (108) maintains a record of the state for each client (104, 110) connection and is responsible for creating audit trail log entries for all database transactions. This ensures that no transaction needs to be specifically coded to have a complete audit trail. Each client (104, 110) connection has its own connection and authentication built in to each communication to maintain system integrity and security.

The client (104, 110) software layer of the present embodiment is also developed in C# code. The client layer is responsible for the user experience with the system, including data review and entry. The client (104, 110) application service software layer is adapted to run on a stationary or portable computing device, and one of ordinary skill will appreciate that the software language in which the client layer is developed may be determined by the particular hardware needs and is within the ordinary level of skill. In this embodiment client (104, 110) network communication with the application server (108) is through the WCF (106 and 112, respectively). The clients (104, 110) are adapted to allow for the network connection to be lost (wired or wireless) without loss of access to working data by maintaining an application server application service layer (138, 148) running on each client computer, which allows for the asynchronous communication with the central application server (108) upon restoration of the network connection. In particular, a portable client (104) includes and utilizes a separate copy of the patient data (132, 142), drug data (134, 144), and large object file data (136, 146) of the central database (102) as a cache copy. When a user accesses data on the portable client (104), he or she is accessing the local cache copy (132, 134, and 136). However, given the limited data storage capabilities of such a portable computing device only a relevant and desired portion of the central database (122, 124, and 126) is replicated (partial replication).

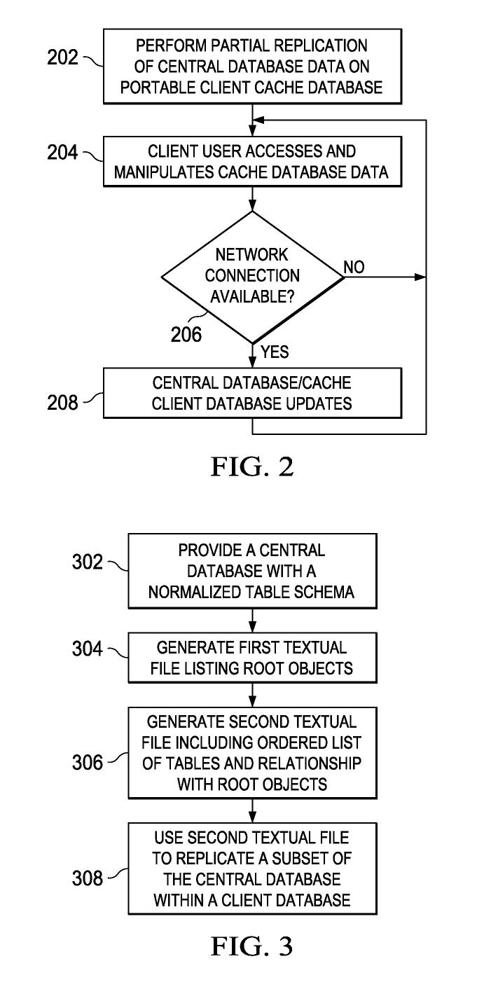

FIG. 2 is a flow diagram depicting certain processing steps of the cache client in maintaining data integrity and coherency with the central database. As shown, the portable client cache database, when connected over the network to the central database server, is partially replicated (202) using the novel techniques disclosed herein. The client user is then allowed to access and manipulate this desired and relevant portion of the cache database (204). If the portable client device network connection is lost (206), the user may still access and manipulate the cache database copy of the data (204). Once network access is restored (206), the application service updates any necessary records on both the central database and the client cache database as necessary (if a record changes on one, the change is reflected on the other). The portable client user then continues to access and manipulate the cache database data as necessary (204). By having a cache database as local access to the partially replicated data, a continuous network connection with the central database server is not necessary except to perform periodic updates. Thus, if the portable client is accessing the central database server over an unreliable network connection, the user does not perceive the interruption because of the continuous access to the local cache database data. Moreover, because only a relevant and desired portion of the central database server data resides on the portable client cache database, the updating requirements are less demanding (a lower bandwidth, periodic network connection is tolerable).

Referring once more to FIG. 1, the present embodiment includes one or more portable clients (104), as well as one or more fixed, remote site client servers (110) that allow for a remote location to maintain data integrity and coherency despite having a low bandwidth network connection (112) with the central server (102). The remote site server (110) provides independent databases (142, 144, and 146) with a table structure matching that of the central database (122, 124, and 126) with replicated data from the central database server (102). The remote site server (110) may be viewed from the central server (102) in the same fashion as an external client, given the similar data needs required by the clients (portable or stationary).

Because this remote site server (110) is essentially stationary, either all or a portion of the central server (102) data may be utilized. However, with a low bandwidth connection (112) it may be more practical to replicate only a portion of the central server (102) database (122, 124, and/or 126) data records for use at the remote location. Replicating only a portion of the data may also be desirable, for example, to reduce the amount of hardware and storage capacity necessary for the remote site. For example, a large hospital may utilize a patient database having hundreds of millions of records that span numerous servers. A remote facility may require access to only a fraction of the overall patient records, thereby requiring only a partial, targeted replication of the central database server data. Portable client devices (150) may then access the remote database data (142, 144, and 146) directly when connected to the remote server (110) over the network. The remote site might also include one or more portable clients having cache databases (for example, 104), wherein the portable client obtains a local copy of the data (for example, 132, 134, and 136, likewise having a matching table structure) from the remote server (142, 144, and 146), thus preventing any perceived loss of data connectivity even if the portable client network connection is unreliable. In the previous example of the large hospital/remote facility, a portable client device that is being used by a doctor to see only a fraction of the remote facility's patients would, likewise, only require a partial but targeted replication (limited to the patients being seen) of the remote facility database server data. Thus, the portable client device database storage requirements would be reduced.

The present embodiment also allows remote access to the central database through an Internet portal (116) to allow for administrative control over various aspects of the system. The portal maintains a web server (154) and an application server (152) to communicate securely with the central office central database (102). The portal in the present embodiment is web browser based, but may also utilize a dedicated user interface running as an application on the server (154).

FIG. 3 presents a flow diagram depicting certain high-level processing steps taken by the embodiment in performing the overall stated functionality. In particular, this flow diagram highlights processing steps involved in the previous example of system operation. For example, the hospital's central relational database is created with a normalized table schema to contain large numbers of patient records and associated data (302). The user generates a first textual file that includes a listing of root objects of interest within the central database (304). The system then utilizes the first textual file to execute a replication structuring utility in the form of a replication structuring device to parse the database table structure and to generate a second textual file that includes an ordered list of the tables and the table relationship with the root objects (if any such relationship exists) in a tree data structure format (306). This second textual file is a flat file that includes the table structure relationships with the root objects, which is then used for determining the optimum order of replication of the central database table data or the remote site database table data. This second textual file is utilized by the client server when replicating the desired portion of the data residing on the central database server (308), by allowing the remote site server to focus solely on the root objects when navigating the table structure via SQL queries.

A “root object” is a marker to define a record group of interest and to stripe a series of tables in the database. For example, in a database containing patient records the “root object” might be the Patient, Message, User, or Provider. Thus, in the case of a Patient, the records access would be focused on the particular patients that exist in the database. Likewise, for User the records access would be focused on those records associated with a particular user (ex. Doctor). One of ordinary skill in the art will appreciate that other “root objects” may be defined as appropriate for a desired application.

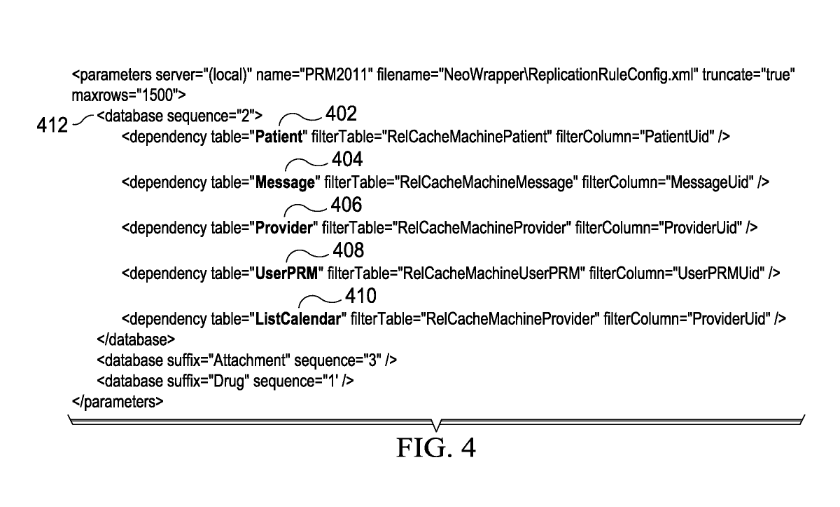

FIG. 4 presents a graphical depiction of the contents of an embodiment of the first textual file including root object definitions as utilized by the present embodiment. The depicted file content is in XML format, and specifies the root objects around which the database tables will be structured to enable efficient partial replication. This textual file is generated in XML format by the replication structuring utility to allow for a more standardized handling of the file contents using XML parsing and generation utilities, for example, MSXML/XSLT, DOM, JAXP, etc. Other embodiments may utilize similar hierarchical textual document information standards, for example, JSON. As shown, the file is arranged to specify root objects including “Patient” (402), “Message” (404), “Provider” (406), “User” (408), and “Calendar” (410). In this example, the instructions being provided to the replication structuring utility indicate that the tables must be ordered such that records can be replicated based on any of these specified root objects (402 to 410). The sequence in which the database tables are parsed is also specified (412).

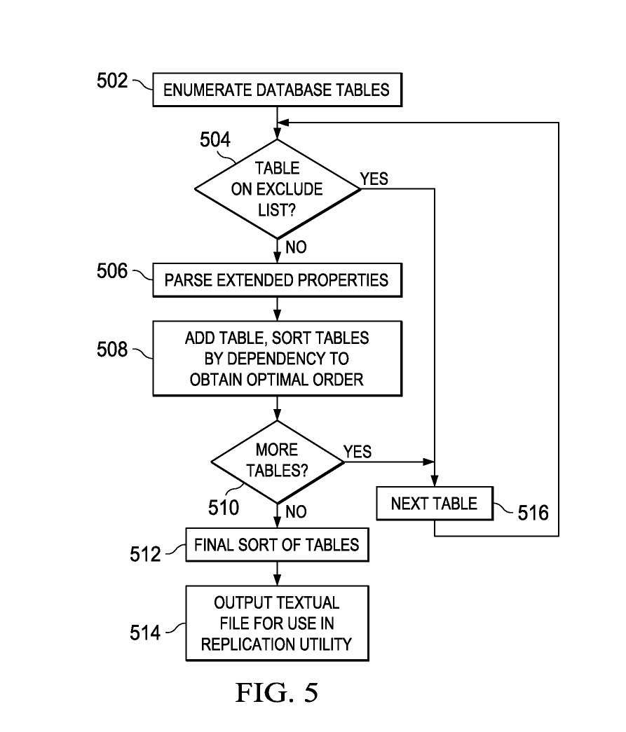

FIG. 5 is a flow diagram depicting certain processing steps taken by the embodiment when using the first textual file to generate a second textual file for use by the system when performing partial replication of the central database. Again, the first textual file serves as an input to the replication structuring utility. The utility parses the first textual file to ascertain the root objects of interest and table sequence, and begins enumeration of the central database tables (502). Each table is considered individually, and if a particular table is found to be on an exclude list, it is bypassed and the next table is considered. The exclude list is a list of tables that should not be included in the replication process, as defined by a user or as defined by the root objects. This list may be present in metadata associated with the individual central database tables, present as a prefix of the table name, or may be apparent based on missing column data required by a replication utility, and serves as a hint to the structuring utility.

If the table being considered by the utility is on the exclude list (504), the next table is considered (516). If the table being considered by the utility is not on the excluded list (504), the extended properties of the table are parsed to obtain additional processing hints. Because relational database table schemas are highly complex with regard to table and data dependencies, it is also necessary to provide these metadata “hints” for table data handling. For example, consider the situation in which data from hypothetical Table A is to be replicated, but this data is impossible to replicate without first replicating data from Table B. The system allows the user to enter a metadata “hint” alongside the Table A structure that informs the replication structuring utility of this dependency. Other metadata hints include conflict resolution, business rules, record looks, post processing instructions, etc. The table is then sorted in the dependency generator and placed into an initial optimal order depending on the foreign key relationships (508). This sequence is repeated until all tables have been considered (510). If tables remain, the next table is considered (516) and the process repeats. Once all tables are considered (510), a final sort is performed to ensure that all tables are in optimum order (512). If circular dependencies exist, the most referenced table is placed first and any extended properties (hints) can be used to override sorting if necessary. The utility then generates a second textual file for use by the replication utility (514).

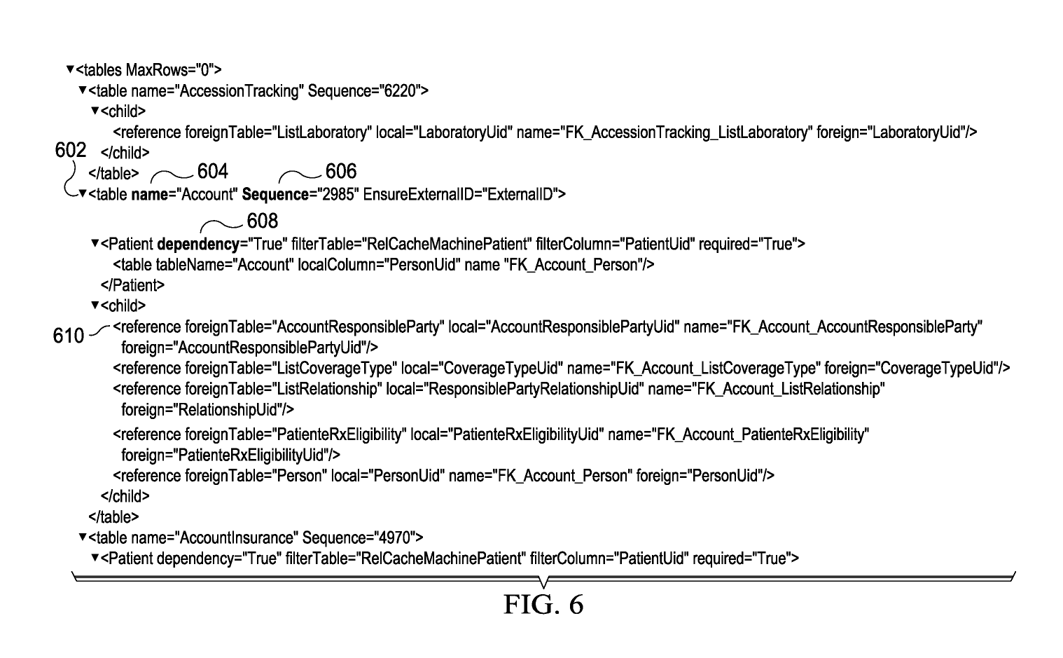

FIG. 6 is a graphical depiction of the contents of a portion of an embodiment of the second textual file including an ordered listing of database tables in an optimal replication order. In this instance, focus is on the “Patient” root object. The second textual file includes, as a root element (602), relevant table data including a name (604), sequence number (606), and dependency indicators (608) with related table data included as child elements (610) appearing thereunder. Other root objects are handled in a similar fashion and are also included as entries. The textual file creation utility structures the ordered list of tables in the file such that the root object serves as a root element, and the path from the child elements back to the root element (root object) is optimized and clearly defined. Thus, when a partial replication of the central database table is performed, the client or remote site server need only navigate the ordered list in the textual file to obtain the root objects of interest, replicating only the data records associated with the root objects of interest.

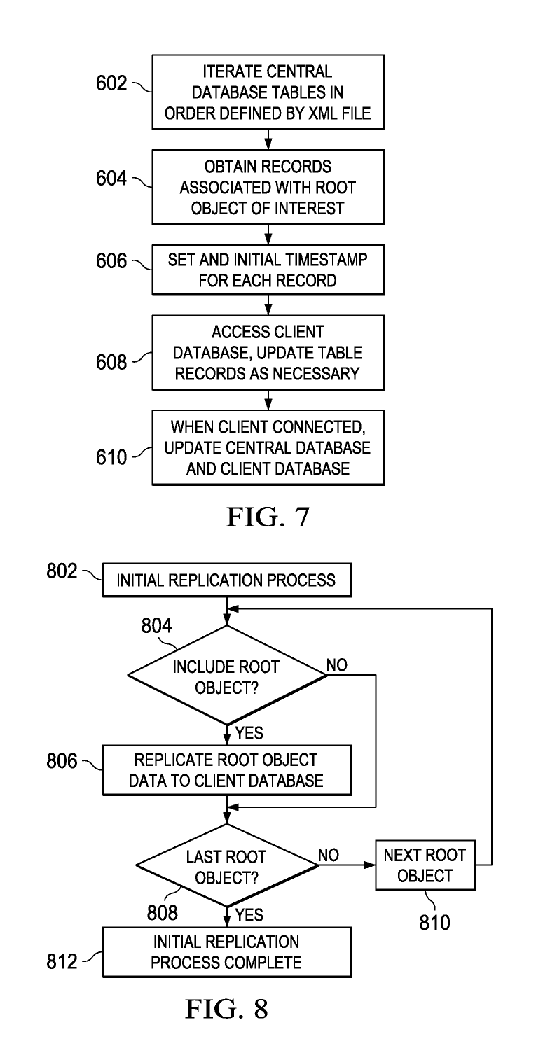

FIG. 7 is a flow diagram depicting certain processing steps taken by the embodiment when replicating at least a portion of the central database on a client device. The replication utility accepts the second textual file as an input, specifying the optimum ordering of central database tables for each root object. For example, if a portable client device requires database updates concerning patient appointments for a given calendar date, the root object of interest is ListCalendar. The replication utility iterates the central database tables in the order defined by the second textual file (602), focusing specifically on the optimized ordering of the ListCalendar root object tables and records. The records associated with the root object are obtained (604). An initial timestamp is associated with each record in the client cache database (606), and is updated whenever the client accesses the particular record data (608). When the client is connected to the central database (or remote site database) over a suitable network, the client cache data is updated with newer data from the central database (or remote site database) or vice versa, depending on the timestamp (610). Thus, a portable client with a cache database always has access to needed data despite the network connectivity. Referring once more to FIG. 1, the system is also accessible by one or more portable clients without a cache database (114). In this situation a portable client only has access to central server data when connected to the network, as no local cache copy exists. This portable client without a cache database (114) may also be utilized with a remote site database, which would provide it with access to a smaller segment of the data that the central database could provide.

During the replication process by the replication utility the tables are processed in the order presented in the second textual file. The replication utility may also generate SQL queries based upon the second textual file information, facilitating the database calls required during the replication process. If a particular table has no relationship to a root object, all of the inserted/updated/deleted rows of data are replicated on the portable client database. If a relationship to a root object is found only the rows that were inserted/updated/deleted and related to the root object are replicated. Thus, partial replication reduces the data replication burden for client devices.

FIG. 8 is a flow diagram depicting certain processing steps taken by the embodiment when performing the initial replication process. Once the database schema is installed on the cache client database the initial replication process (802) is necessary populate the desired row data. Because the client database is empty at this point, change tracking is not at issue. Instead, each database table is considered to determine if a row must be replicated. The replication utility, using the second textual file, populates the cache client database table row data by considering the desired root objects in order. If a root object should be included (804), the root object row data for the table is replicated in the client database (806) and, if not the last root object (808), the next root object is considered (810). If the root object is not included (804), no replication occurs and, if not the last root object (808), the next root object is considered (810) and the process is repeated. Once the final root object is considered (808), the replication process completes (812).

The central database contains a global sync anchor that acts as a marker in time. This sync anchor assists the database engine in tracking all changes made to the table after the sync anchor is established. The replication engine can then query from the database all changes to a particular table that have occurred since a given sync anchor. The system stores the last sync anchor for a replication event, and when the current replication event is complete updates the sync anchor to the current updated table state so that during the next replication pass only data changed since the last synchronization is requested.

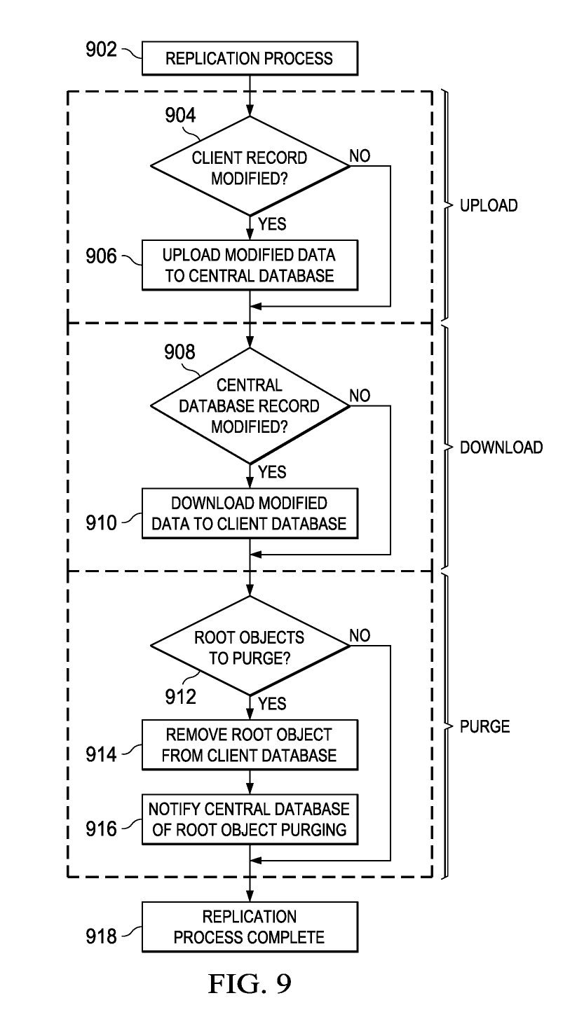

FIG. 9 is a flow diagram depicting certain processing steps taken by the embodiment when performing the ongoing replication process. On an ongoing basis, it is necessary for the replication utility to periodically complete the replication process (902) to ensure that all data record changes are captured. On a per record basis, for root objects of interest, the utility first considers whether the client record has been modified (904) and if it has been modified, uploads the modified client data to the central database (906). Next the utility considers whether the central database record has been modified (908) and if it has been modified, downloads the modified data to the client database (910). Finally, if a particular root object has been marked as no longer needed or desired for the client (912), the root object data is removed from the client database (914) and the central database is notified of the root object purging (916) so that this root object data is not replicated to the client database on subsequent replication process passes. The replication process is thus completed (918) and rescheduled to run by the utility.

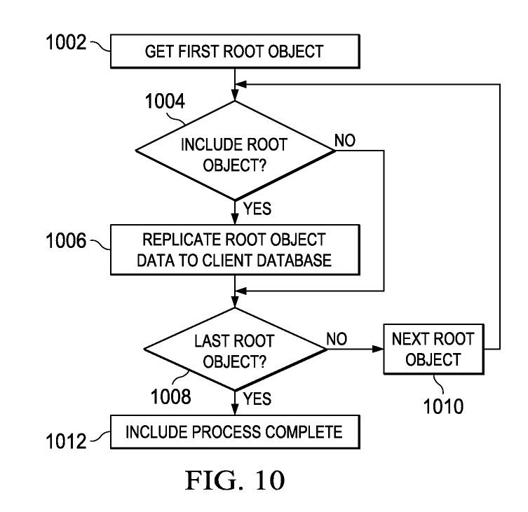

FIG. 10 is a flow diagram depicting certain processing steps taken by the embodiment when performing the include process. During this process, which runs periodically on the central database server, the root objects are periodically considered to determine if an instance of the root object should be replicated on a client database. For example, if a patient is added to a healthcare provider's schedule to be seen on a certain date, the replication utility must be notified of this addition so that the patient data may be replicated on the client database during the next replication process pass. As depicted, the first root object is considered (1002) and if marked for inclusion (1004), the root object data is replicated to the client database (1006). If root objects remain (1008), the next root object is considered (1010) and replicated (1006) if necessary. Once the final root object has been considered (1008), the process is completed (1012) and rescheduled to run by the utility.

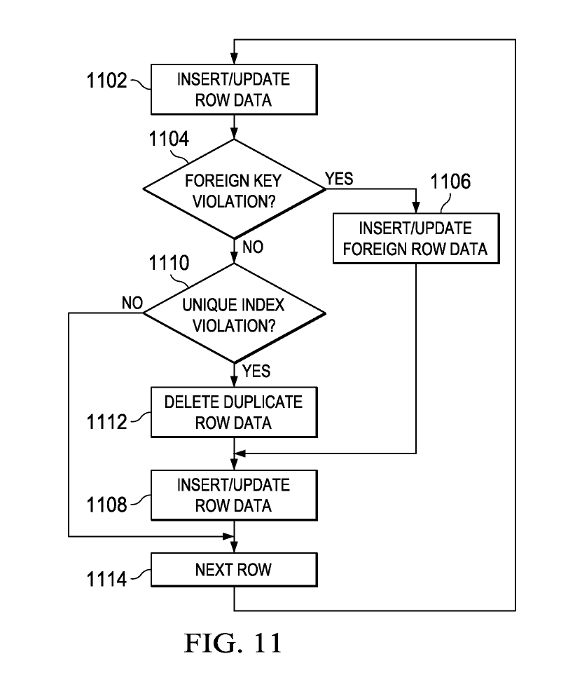

During the replication process (initial and ongoing) there can be times when a SQL call returns an error because of a foreign key or unique index violation. FIG. 11 presents a flow diagram depicting certain processing steps taken by the embodiment when a row data error is encountered during replication. In response to an INSERT/UPDATE row data call (1102), if a foreign key violation is encountered because of missing foreign key data (1104), the replication utility first obtains the missing foreign row data (1106) before inserting/updating the desired row data (1108). If a unique index violation occurs because of duplicate row data (1110), the duplicate row data is deleted prior to the inserting/updating of the desired row data (1108). The next row data is considered (1114) and, if the replication utility encounters the same errors on the foreign row/duplicate row data, can cascade this process as deep as necessary to complete the replication process for the original row (1102).

As discussed previously, client and remote site computing devices each communicate with the central database device application server over a network connection, which may be wired or wireless depending on the needs of the client. The application service layer maintains connection state information for each device along with data transfer state information. In the present embodiment data is exchanged between the central database server and the connected device in a packetized format, which includes sequence and integrity information. Therefore, if a connection is lost during a data transfer the application server is able to determine the exact position in the data chain where the interruption occurred, and can then resume the data transfer from that position once the client/remote site device reconnects. Moreover, the application service layer is able to check the integrity of each data packet to ascertain validity and can instruct the transmitting device to repeat a given packet if found invalid. If the audit data shows that a given client/remote site device is susceptible to frequent network connection interruptions or indicates a very low bandwidth connection, the application service layer can dynamically adjust the packet size and frequency to minimize such data losses or interruptions.

Because the embodiment allows multiple clients and remote site devices to connect to a central database simultaneously, conflicts must be managed. The present embodiment maintains data record modification timestamps on the central database server as well as locally with each connected device. Thus, if it is determined that a client/remote site device contains record data that is more fresh than the central database record data, the central database record data is updated. Likewise, when the central database data is the freshest, the modified data is replicated at the client devices if necessary (not all central database data is replicated on all connected devices—partial replication). However, consider the situation in which Client A and Client B each have access to the same patient record on the central database, and Client A is on a wireless connection prone to interruption while Client B is on a stable wired connection. If Client A were to modify the patient record while disconnected from the network, this update would not propagate to the central database record and, thus, Client B would be unaware of Client A's modifications. If Client B were to make an update to the patient record this update would essentially propagate to the central database server record immediately. Thus, once Client A reconnected and tried to update the record on the central database server, the original record would have already been modified. The central database server logic maintains the record modification timestamps and is able to note that the original patient record was modified and prompt the user on Client A to verify which modification should apply to the patient record. Notification may also be provided to the user on Client B regarding the conflict.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes that come within the meaning and range of equivalency of the claims are therefore embraced therein. Further, the recitation of method steps does not denote a particular sequence for execution of the steps. Such method steps may therefore be performed in a sequence other than that recited unless the particular claim expressly states otherwise.

We claim:

1. A system for selectively replicating electronic data in a database, the system comprising:
at least one central database device adapted to store a multitude of electronic data organized in a normalized table schema; and
a replication structuring device adapted to utilize a first textual file, the first textual file comprising a list of root objects of interest, the replication structuring device generating a second textual file comprising an ordered listing of the central database tables based upon the first textual file input.

2. The system of claim 1 further comprising:
at least one client computing device including at least one client database device, the client computing device adapted to utilize the second generated textual file to replicate a subset of the central database within the client database.

3. The system of claim 1 wherein the first textual file is an XML-based format document.

4. The system of claim 1 wherein the second textual file is an XML-based format document.

5. The system of claim 1, the system further comprising:
a replication utility adapted to generate SQL database queries based on the second textual file, wherein the SQL database queries facilitate the replication of a subset of the central database data.

6. The system of claim 1 wherein the second textual file data is organized in a tree structure based upon the root objects of interest for determining the optimum order of replication of the central database tables.

7. The system of claim 1 wherein the central database schema includes metadata for use by the replication structuring device to determine the order in which the central database table data must be replicated to avoid constraint violations during the subset replication.

8. The system of claim 1 wherein the client computing device is in wireless communication with the central database device.

9. The system of claim 1 further comprising:
an application server device in network communication with the at least one client computing device, the application server device adapted to cooperate with the at least one client computing device and the at least one central database device to assist in maintaining data coherency.

10. The system of claim 1 further comprising:
an application server device in network communication with the at least one client computing device, the application server device adapted to cooperate with the at least one client computing device and the at least one central database device to monitor the client device connection state for audit-trail purposes.

11. A method for selectively replicating electronic data in a database, the method steps comprising:
providing a central database including a multitude of electronic data organized in a normalized table schema;
using a first textual file comprising a list of root objects of interest to generate a second textual file comprising an ordered list of table and element relationships within the central database table schema; and
using the second textual file to replicate a subset of the central database within a client device database.

12. The method of claim 11 wherein the first textual file is an XML-based format document.

13. The method of claim 11 wherein the second textual file is an XML-based format document.

14. The method of claim 11, the method steps further comprising:
using the first textual file to determine the optimum order of replication of the central database tables.

15. The method of claim 11, wherein the second textual file data is organized in a tree structure having root objects of interest for determining the optimum order of replication of the central database tables.

16. The method of claim 11, the method steps further comprising:
defining a plurality of root objects that are of interest within the central database records;
identifying all records within the central database related to the root objects;
organizing the identified records into a tree structure; and
mapping the paths through the tree structure to determine the optimum paths to the root objects.

17. The method of claim 11, the method steps further comprising:
utilizing metadata stored with the central database tables to assist in determining the order in which the central database table data must be replicated to avoid constraint violations during the subset replication.

18. The method of claim 11, wherein the client database is on a client computing device, the method steps further comprising:
monitoring the network connection between the client computing device and the central database for audit trail purposes.

19. The method of claim 11, the method steps further comprising:
replicating wirelessly the subset of the central database.
